(19) United States
(12) Patent Application Publication
(10) Pub. No.: US 2025/0188362 A1
(43) Pub. Date: Jun. 12, 2025

(54) METHOD AND DEVICE FOR PRODUCING WASTE PLASTIC PYROLYSIS OIL WITH REDUCED CHLORINE

(71) Applicants: SK INNOVATION CO., LTD., Seoul (KR); SK GEO CENTRIC CO., LTD., Seoul (KR)

(72) Inventors: Sanghwan JO, Daejeon (KR); Sookil KANG, Daejeon (KR); Howon LEE, Daejeon (KR); Jaeheum JUNG, Daejeon (KR); Serah MOON, Daejeon (KR); Hee Young JEON, Daejeon (KR)

(21) Appl. No.: 18/844,390

(22) PCT Filed: Mar. 9, 2023
(86) PCT No.: PCT/KR2023/003219

§ 371 Date: Sep. 6, 2024

(30) Foreign Application Priority Data
Mar. 17, 2022 (KR) 10-2022-0033136

(51) Int. Cl. C10G 1/10; C10G 1/00

(52) U.S. Cl. CPC C10G 1/10; C10G 1/002; C10G 2300/1003; C10G 2300/4006; C10G 2300/4037; C10G 2300/706

(57) ABSTRACT

Embodiments of the present disclosure provide a method for producing waste plastic pyrolysis oil with reduced chlorine, the method including a first operation of charging a waste plastic raw material and an accelerator containing char into a reactor; a second operation of pyrolyzing the waste plastic raw material in the reactor and recovering pyrolysis oil; and a third operation of recovering the accelerator from the reactor.

### CROSS-REFERENCES TO RELATED APPLICATION

The present application is a national phase entry of PCT/KR2023/003219 filed on Mar. 9, 2023, and claims priority under 35 U.S.C. § 119(a) to Korean Patent Application Number 10-2022-0033136, filed on Mar. 17, 2022, which is incorporated herein by reference in its entirety.

### BACKGROUND

### Technical Field

Embodiments of the present disclosure generally relate to a method and device for producing pyrolysis oil with reduced chlorine from waste plastics.

### Related Art

Solid fuel is a material produced by subjecting combustible waste such as waste plastics, waste fibers, waste tires, waste paper, waste wood, oil, and livestock by-products among industrial waste and general waste to a sorting process, a crushing process, a drying process, a chemical treatment process, and a molding process. Recently, an interest in energy conversion using waste resources such as solid fuel has increased. A combustion, gasification, or pyrolysis process may be performed for energy conversion of solid fuel, and char, which is a by-product, is formed during this process.

Among the solid fuels, waste plastics, which are produced using petroleum as a raw material, are not recyclable and are mostly disposed of as garbage. These wastes take a long time to degrade in nature, causing contamination of the soil and serious environmental pollution. As a method for recycling waste plastics, a method for converting waste plastics into oil by pyrolysis of the waste plastics has been performed.

However, pyrolysis oil obtained by pyrolyzing waste plastics cannot be immediately used as a high-value-added fuel such as gasoline or diesel oil because it has a higher content of impurities such as chlorine, nitrogen, metals, and solid by-products than fractions produced from crude oil by a general method, and therefore, pyrolysis oil may be used as a fuel after the impurities are adsorbed through a refinery process.

In the refinery process of pyrolysis oil according to the related art, chlorine has been converted into hydrogen chloride by hydrotreating the chlorine in the presence of a hydrotreating catalyst to be adsorbed and removed. However, since waste plastic pyrolysis oil contains a high content of chlorine, an excessive amount of hydrogen chloride is generated during hydrotreating, which causes equipment corrosion, an abnormal reaction, and deterioration of product properties.

In addition, in a method for reducing chlorine, nitrogen, and the like using a dechlorinating agent such as a metal hydroxide, a metal oxide, or a waste fluid catalytic cracking (FCC) catalyst (E-cat), the dechlorinating agent should be used in an excessive amount (at a level of 2 to 50 times the oil to be refined). Accordingly, the dechlorinating agent remains in the produced pyrolysis s oil, which makes it difficult to obtain high-quality pyrolysis oil. In addition, an adsorbent is deteriorated in a process of adsorbing chlorine, nitrogen, and the like, resulting in a reduction in the adsorption ability of the adsorbent. Thus, the deactivated adsorbent should be continuously replaced.

Therefore, there is a demand for a technique capable of producing waste plastic pyrolysis oil in which a content of chlorine is minimized from waste plastics.

### SUMMARY

Embodiments of the present disclosure provide a method and device for producing waste plastic pyrolysis oil that may effectively reduce chlorine using char, which is a by-product produced in a waste plastic pyrolysis process, and may improve cost-effectiveness through reuse of the char.

Embodiments of the present disclosure also provide a method and device for producing waste plastic pyrolysis oil that may effectively reduce chlorine using physicochemical properties of char and a dechlorinating agent.

Embodiments of the present disclosure further provide a method and device for producing waste plastic pyrolysis oil having a low content of chlorine at a level that allows pyrolysis oil to be directly introduced into a refinery process without a post-treatment process of the pyrolysis oil.

In an embodiment of the present disclosure, a method for producing waste plastic pyrolysis oil with reduced chlorine includes a first operation of charging a waste plastic raw material and an accelerator containing char into a reactor; a second operation of pyrolyzing the waste plastic raw material in the reactor and recovering pyrolysis oil; and a third operation of recovering the accelerator from the reactor.

In an embodiment, the accelerator in the first operation may be charged into the reactor in an amount of 5 to 30 parts by weight with respect to 100 parts by weight of the waste plastic raw material.

In an embodiment, the accelerator may further contain one or more dechlorinating agents selected from the group consisting of a metal oxide, a metal hydroxide, and a metal carbonate.

In an embodiment, the dechlorinating agent may be a metal oxide.

In an embodiment, the accelerator may be an aggregate in which a plurality of first particles containing char are bound and aggregated by the dechlorinating agent.

In an embodiment, the dechlorinating agent may be an adhesive powder further containing moisture, and may bind the plurality of first particles.

In an embodiment, the char may be contained in the accelerator at a weight greater than that of the dechlorinating agent.

In an embodiment, the method may further include a fourth operation of resupplying the accelerator recovered in the third operation to the first operation.

In an embodiment, the fourth operation may include an operation of washing the accelerator recovered in the third operation with an alcohol; an operation of replenishing the accelerator washed with the alcohol and the dechlorinating agent to prepare an accelerator; and an operation of resupplying the prepared accelerator to the first operation.

In an embodiment, the second operation may be performed at a temperature of 300 to 600° C.

In an embodiment, the second operation may be performed in a non-oxidizing atmosphere.

In an embodiment, the method may further include, before the operation of resupplying the prepared accelerator to the first operation, an operation of additionally heating the prepared accelerator at 500 to 1,000° C. to improve activity of the accelerator.

In another embodiment, a device for producing waste plastic p pyrolysis oil with reduced chlorine includes a reactor into which a waste plastic raw material and an accelerator containing char are charged and in which a pyrolysis process is performed; and a storage tank in which pyrolysis oil is recovered from the reactor.

In an embodiment, the device may further include a recovery tank that recovers the accelerator from the reactor; and a recirculation line that resupplies the accelerator from the recovery tank to the reactor.

### Advantageous Effects

According to the embodiments of the present disclosure, since the char, which is a by-product produced in the waste plastic pyrolysis process, is reused and utilized as a useful resource, the cost-effectiveness is improved, and chlorine is effectively reduced through excellent chemical resistance and adsorption properties of the char, such that the process efficiency may be improved.

According to the embodiments of the present disclosure, it is possible to produce pyrolysis oil having a low content of impurities at a level applicable to a refinery process without performing an additional post-treatment process after pyrolyzing the waste plastic raw material.

According to the embodiments of the present disclosure, energy consumption may be effectively saved compared to the existing waste plastic pyrolysis process.

### DETAILED DESCRIPTION

Unless the context clearly indicates otherwise, the singular forms of the terms used in the present specification may be interpreted as including the plural forms.

A numerical range used in the present specification includes upper and lower limits and all values within these limits, all double limited values, and all possible combinations of the upper and lower limits in the numerical range defined in different forms. Unless otherwise specifically defined in the present specification, values out of the numerical ranges that may occur due to experimental errors or rounded values also fall within the defined numerical ranges.

The expression “comprise(s)” described in the present specification is intended to be an open-ended transitional phrase having an equivalent meaning to “include(s)”, “contain(s)”, “have (has)”, or “are (is) characterized by”, and does not exclude elements, materials, or operations, all of which are not further recited herein.

Unless otherwise defined, a unit of “%” used in the present specification refers to “wt %”.

Unless otherwise defined, a unit of “ppm” used in the present specification refers to “mass ppm”.

Waste plastics include polyethylene (PE), polypropylene (PP), polyethylene terephthalate (PET), polyvinyl chloride (PVC), polystyrene (PS), and the like, and the waste plastics contain impurities such as organic chlorine and inorganic chlorine. Pyrolysis oil produced through a waste plastic pyrolysis process cannot be immediately used as a high-value-added fuel such as gasoline or diesel oil because it has a high content of impurities, and therefore, pyrolysis oil may be used as a fuel after the impurities are adsorbed through a refinery process. However, since waste plastic pyrolysis oil contains a high content of chlorine, an excessive amount of hydrogen chloride is generated during hydrotreating, which causes equipment corrosion, an abnormal reaction, and deterioration of product properties. Therefore, there is a demand for a technique of producing waste plastic pyrolysis oil having a low content of impurities at a level that allows pyrolysis oil to be directly introduced into a refinery process without an additional post-treatment process.

Accordingly, an embodiment of the present disclosure provides a method for producing waste plastic pyrolysis oil with reduced chlorine, the method including a first operation of charging a waste plastic raw material and an accelerator containing char into a reactor; a second operation of pyrolyzing the waste plastic raw material in the reactor and recovering pyrolysis oil; and a third operation of recovering the accelerator from the reactor.

The waste plastic raw material may be domestic plastic waste, industrial plastic waste, or mixed waste plastics thereof. The domestic plastic waste is a plastic in which PVC, PS, PET, PBT, and the like in addition to PE and PP are mixed. In the present disclosure, as an example, the domestic plastic waste may be a waste plastic including 3 wt % or more of PVC together with PE and PP. A content of chlorine may be 5,000 ppm or more with respect to 100 parts by weight of the domestic plastic waste, and specifically, may be 5,000 to 15,000 ppm with respect to 100 parts by weight of the domestic plastic waste, but this is merely an example, and the content of chlorine is not limited thereto.

The industrial waste plastic is industrial waste generated during a manufacturing process in industries, and may be a waste plastic including PE and PP as main components. Since the industrial waste plastic maintains a relatively clean state, a content of chlorine is lower than that in the domestic waste plastic. However, a content of organic chlorine derived from an adhesive or a dye component is high, and in particular, a ratio of chlorine contained in an aromatic ring is high. The content of chlorine may be 100 to 1,000 ppm, specifically, 500 to 1,000 ppm, and more specifically, 700 to 1,000 ppm, with respect to 100 parts by weight of the waste plastics, but this is merely an example, and the content of chlorine is not limited thereto.

Since waste plastics have low heat conductivity, a significant amount of fuel is consumed in the pyrolysis process, and the waste plastics are not uniformly heated, which causes occurrence of a local temperature deviation, resulting in low reaction efficiency. Accordingly, as the waste plastic raw material and the accelerator containing char are charged into the reactor in the first operation, and then the pyrolysis process is performed in the second operation, the pyrolysis is accelerated, such that the process efficiency may be improved, and at the same time, the content of chlorine in the produced pyrolysis oil may be effectively reduced. As the accelerator containing char acts as a heat carrier in the waste plastic pyrolysis process, the low heat conductivity of the waste plastics may be compensated for, such that heat transfer between waste plastic particles may be accelerated, the consumption of fuel may be saved, and the pyrolysis process may be accelerated, thereby improving the process efficiency. Incidentally, the char is a by-product mainly produced in an energy conversion process of solid fuel and is distributed at low cost, and thus it is possible to achieve a reduction in cost of the waste plastic pyrolysis process and improvement of cost-effectiveness.

In addition, due to developed pores of the char, the char may effectively adsorb organic chlorine and inorganic chlorine derived from the waste plastics during the pyrolysis process, such that the content of chlorine in the produced pyrolysis oil may be effectively reduced. Specifically, the char contains calcium carbonate, and chlorine dissociated from the waste plastics during the pyrolysis process remains while being adsorbed to the char, such that the dissociated chlorine recombines with olefins in the pyrolysis product, and as a result, regeneration of organic chlorine may be suppressed. Specifically, the content of chlorine in the pyrolysis oil produced by the pyrolysis process may be reduced by 80% or more of the content of chlorine contained in the waste plastic raw material. More specifically, the content of chlorine in the pyrolysis oil produced by the pyrolysis process may be reduced by 90% or more, and may be reduced by 90% or more and 97% or less without limitation.

That is, as the accelerator containing char is used in the waste plastic pyrolysis process, the content of chlorine in the produced waste plastic pyrolysis oil may be effectively reduced, and at the same time, both the acceleration of the pyrolysis process and the improvement of the process efficiency may be achieved.

In an embodiment, the accelerator in the first operation may be charged into the reactor in an amount of 5 to 30 parts by weight with respect to 100 parts by weight of the waste plastic raw material. Within the above range, chlorine may be effectively adsorbed, and the reaction efficiency may be improved. When the amount of the accelerator containing char is less than 5 parts by weight, the chlorine adsorption effect may be insufficient, and when the amount of the accelerator containing char is 30 parts by weight or more, the accelerator may be saturated due to excessive addition, and the purity of the produced pyrolysis oil may be reduced. Specifically, the amount of the accelerator containing char may be 5 to 25 parts by weight, and more specifically, may be 5 to 20 parts by weight.

In an embodiment, the accelerator may further contain one or more dechlorinating agents selected from the group consisting of a metal oxide, a metal hydroxide, and a metal carbonate. Since the accelerator further contains a dechlorinating agent, the chlorine adsorption effect of the accelerator may be further improved. The metal may be an alkali metal or an alkaline earth metal, and specifically, may be sodium, magnesium, potassium, calcium, or the like. Specifically, the dechlorinating agent may be calcium hydroxide, sodium hydroxide, magnesium hydroxide, potassium hydroxide, calcium oxide, magnesium oxide, calcium carbonate, sodium carbonate, potassium carbonate, or the like.

In an embodiment, the dechlorinating agent may be a metal oxide. In particular, when a metal oxide is used as the dechlorinating agent, chlorine generated in the waste plastic pyrolysis process may be further effectively adsorbed, and it may be preferable to use a metal oxide in terms of aggregation with a plurality of particles containing char described below. Specifically, the dechlorinating agent may be calcium oxide, magnesium oxide, sodium oxide, or potassium oxide, and preferably, may be calcium oxide.

In an embodiment, the accelerator may be an aggregate in which a plurality of first particles containing char are bound and aggregated by the dechlorinating agent. The char is a type of carbide particles, and in the present specification, individual char particles are primary particles and are referred to as first particles. The dechlorinating agent acts as a binder, and the dechlorinating agent is positioned between the plurality of first particles as a binder, which may allow the char first particles to form an aggregate, which is a secondary particle. As the accelerator has an aggregate structure, heat transfer to the waste plastics may be accelerated, and chlorine generated by the heat transfer may be effectively trapped by the accelerator adjacent to the chlorine. Specifically, physical adsorption by fine pores of the char contained in the accelerator and chemical adsorption by the dechlorinating agent are effectively implemented, such that the chlorine removal effect may be maximized. In particular, in a case where a metal oxide is used as the dechlorinating agent, binding properties with the plurality of first particles are excellent, and the aggregation may occur more stably, which is preferable. Specifically, the dechlorinating agent may be calcium oxide, magnesium oxide, sodium oxide, or potassium oxide, and preferably, may be calcium oxide.

In an embodiment, the dechlorinating agent may be an adhesive powder further containing moisture, and may bind the plurality of first particles. Since the adhesive powder containing moisture is used, a cohesive force between the plurality of first particles is improved, such that a stable aggregate may be formed. Additionally, the chlorine dissociated from the waste plastics is collected by the moisture, such that the chlorine adsorption effect may be improved. Specifically, the moisture may be contained in an amount of 0.1 to 5 parts by weight with respect to 100 parts by weight of the dechlorinating agent. When the moisture is contained in the appropriate range described above, the improvement of the cohesive force of the aggregate may be effectively achieved. More specifically, the moisture may be contained in an amount of 0.5 to 2 parts by weight with respect to 100 parts by weight of the dechlorinating agent. In an embodiment, the char may be contained in the accelerator at a weight greater than that of the dechlorinating agent. Since the char is contained at a weight greater than that of the dechlorinating agent, the chlorine adsorption effect may be further improved. Specifically, a weight ratio of the char to the dechlorinating agent may be 100:10 to 100:40. Since the char and the dechlorinating agent are contained at the above weight ratio, the physical adsorption of chlorine through the fine pores formed on a surface of the char is excellent, which may be preferable. Specifically, the weight ratio may be 100:10 to 100:30, and more specifically, may be 100:10 to 100:25.

An average size of the char may be 0.1 to 5 mm. Within the range satisfying the above size, aggregation by the dechlorinating agent may effectively occur. Specifically, the average size may be 0.1 to 3 mm.

The second operation is an operation of pyrolyzing the waste plastic raw material and recovering pyrolysis oil, a pyrolysis product may contain pyrolysis gas and a solid by-product. After the pyrolysis gas is discharged from the reactor, the pyrolysis gas may be cooled and liquefied to be recovered as liquid pyrolysis oil.

The pyrolysis gas may include, with respect to the total weight of the waste plastic raw material, 5 to 35 wt % of Naphtha (bp to 150° C.), 10 to 60 wt % of Kero (bp 150 to 265° C.), 20 to 40 wt % of LGO (bp 265 to 380° C.), and 5 to 40 wt % of UCO-2/AR (bp from 380° C.), and specifically, may include, with respect to the total weight of the waste plastic raw material, 5 to 30 wt % of Naphtha (bp to 150° C.), 15 to 50 wt % of Kero (bp 150 to 265° C.), 20 to 35 wt % of LGO (bp 265 to 380° C.), and 10 to 40 wt % of UCO-2/AR (bp from 380° C.). In addition, the pyrolysis gas may include a balance of low-boiling hydrocarbon compounds such as methane (CH4), ethane (C2H6), and propane (C3H8).

The third operation is an operation of recovering the accelerator from the reactor, and the accelerator may be recovered from the solid by-product remaining in the reactor after the pyrolysis gas is discharged. In the related art, in a case where the waste plastic pyrolysis process is performed by adding a dechlorinating agent, the dechlorinating agent typically remains in an amount of 5 to 10 wt % in the recovered liquid pyrolysis oil. On the other hand, in embodiments of the present disclosure, the dechlorinating agent remains in the solid by-product in the form of an aggregate in which the dechlorinating agent and the char are aggregated, and thus high-quality pyrolysis oil may be recovered, and an additional post-treatment process for treating the dechlorinating agent remaining in the pyrolysis oil may be omitted. In a method for recovering the accelerator, the accelerator may be recovered through a pyrolysis oil refinery device described below.

In an embodiment, the method may further include a fourth operation of resupplying the accelerator recovered in the third operation to the first operation. The char, which is a by-product of the pyrolysis process, and the dechlorinating agent are recycled as the accelerator in the form of the aggregate, such that it is possible to achieve utilization of waste resources and also to obtain the chlorine adsorption effect described above.

In an embodiment, the fourth operation may include an operation of washing the accelerator recovered in the third operation with an alcohol; an operation of replenishing the accelerator washed with the alcohol and the dechlorinating agent to prepare an accelerator; and an operation of resupplying the prepared accelerator to the first operation. Specifically, the recovered accelerator already adsorbs chlorine in the pyrolysis process and is converted into a metal chloride, and thus may be in a deactivated state. The accelerator containing a deactivated metal chloride is washed with an alcohol, such that a metal chloride having high solubility in the alcohol may be leached and removed, an unreacted dechlorinating agent having a relatively low solubility in the alcohol, for example, calcium oxide, may be allowed to remain, and the residual dechlorinating agent may be bound to the plurality of first particles containing char to form an aggregate. The alcohol may be an aliphatic alcohol, and specifically, may be one or a mixture of two or more selected from methanol, ethanol, propanol, isopropanol, butanol, and 2-ethylhexyl alcohol, but this is merely an example, and the alcohol is not limited thereto. Through a series of processes of washing the recovered accelerator, replenishing the dechlorinating agent to improve the activity of the accelerator, and resupplying the accelerator to the first operation, both the utilization of waste resources and the chlorine adsorption effect may be satisfied.

In an embodiment, the first operation may be performed at a temperature of 300 to 600° C. When the pyrolysis process is performed in the above temperature range, it is possible to prevent fusion of the waste plastics, to improve the aggregation of the char and the dechlorinating agent, and to improve the adsorption efficiency of the chlorine dissociated from the waste plastics to the accelerator. Specifically, the temperature may be 300 to 550° C., and more specifically, may be 350 to 500° C.

In an embodiment, the first operation may be performed in a non-oxidizing atmosphere. The non-oxidizing atmosphere is an atmosphere in which the waste plastics are not burned, and for aggregation of the char, combustion should be prevented by heating without supplying oxygen. For example, the non-oxidizing atmosphere may be an atmosphere in which an oxygen concentration is adjusted to 1 vol % or less, or an atmosphere of an inert gas such as nitrogen, water vapor, carbon dioxide, or argon. The pyrolysis process may be stably performed in the above atmosphere.

The first operation may be performed in the non-oxidizing atmosphere for 150 minutes to 350 minutes, and when the retention time is satisfied, activation of the composition of the non-oxidizing atmosphere and sufficient aggregation of the char and the dechlorinating agent may be performed. Specifically, the retention time may be 170 minutes to 330 minutes, and more specifically, may be 200 minutes to 300 minutes.

In an embodiment, the method may further include an operation of subjecting the recovered accelerator to a heat treatment at 500 to 1,000° C. The chlorine adsorption activity may be improved by activating the accelerator through a pre-treatment process in which the accelerator is heated at the above temperature. The heating may be performed in a non-oxidizing atmosphere, and specifically, the temperature may be 500 to 900° C., and more specifically, may be 600 to 800° C.

The first operation may further include an operation of drying the waste plastic raw material with hot air. In order to improve the pyrolysis efficiency, the waste plastic raw material may be dried with hot air, and the drying may be performed before the pyrolysis process, or the drying and the pyrolysis process may be simultaneously performed. For example, in a case where hot air is blown while performing the pyrolysis of the first operation, the drying of the waste plastics and the activation of the accelerator may be achieved at the same time, which may further improve the chlorine adsorption effect.

The pyrolysis oil recovered in the third operation may include an oil layer and a water layer. Oil-water separation proceeds in the liquid pyrolysis oil to form an oil layer and a water layer in the liquid pyrolysis oil, and when the oil layer and the water layer are separated, the oil layer is immediately recovered or the water layer is discharged to recover the remaining oil layer after adsorption, such that waste plastic pyrolysis oil, which is the oil layer in which chlorine is minimized, may be recovered.

A content of chlorine in the recovered oil layer (pyrolysis oil) may be 300 ppm or less. As described above, the char is added in the waste plastic pyrolysis process, such that the content of chlorine in the produced waste plastic pyrolysis oil may be effectively reduced. In particular, in a case where the aggregate in which the char and the dechlorinating agent are aggregated is used as an accelerator, the chlorine adsorption effect may be further improved, such that the content of chlorine in the pyrolysis oil may be 150 ppm or less, and more specifically, may be 100 ppm or less.

An electric field may be applied to effectively separate the oil layer and the water layer, and the oil layer and the water layer may be separated in a short time by electrostatic adhesion due to application of the electric field. In addition, an additive may be added as necessary to increase the oil-water separation efficiency, and the additive may be a common demulsifier known in the art.

In a case where the water layer is discharged and adsorbed, a density is detected using a density profiler, such that it is possible to prevent the oil layer from being adsorbed together with the water layer when the water layer is adsorbed, and only the water layer may be effectively adsorbed.

In addition, an embodiment of the present disclosure provides a device for producing waste plastic pyrolysis oil with reduced chlorine, the device including a reactor into which a waste plastic raw material and an accelerator containing char are charged and in which a pyrolysis process is performed; and a storage tank in which pyrolysis oil is recovered from the reactor.

The reactor may be a batch reactor or a continuous reactor. In the case of the batch reactor, any type of batch reactor capable of performing stirring and controlling temperature rise may be used, and for example, a rotary kiln type batch reactor may be used. In the case of the continuous reactor, a fixed bed continuous reactor may be utilized.

As the pyrolysis proceeds, pyrolysis gas is discharged through a first outlet located at the top of the reactor. The discharged pyrolysis gas may be introduced into a condenser. The condenser may include a zone through which a coolant flows, and the pyrolysis gas introduced into the condenser may be liquefied by the coolant and converted into pyrolysis oil. A cooling temperature may be 80 to 180° C., and specifically, may be 100 to 150° C. When the liquid pyrolysis oil generated in the condenser rises to a predetermined level, the liquid pyrolysis oil may be transferred and recovered to a storage tank.

A heat exchanger may be further provided between the condenser and the storage tank. The pyrolysis gas uncondensed in the condenser is introduced into the heat exchanger and condensed again, and the generated pyrolysis oil may be recovered to the storage tank. The uncondensed pyrolysis gas is recovered again, such that a reaction yield may be improved.

In an embodiment, the device may further include a recovery tank that recovers the accelerator from the reactor; and a recirculation line that resupplies the accelerator from the recovery tank to the reactor. A solid by-product containing the accelerator may be discharged through a second outlet located at the bottom of the reactor, and the discharged solid by-product may be introduced into the recovery tank.

The recovery tank may include an alcohol supply unit. The solid by-product may include an unreacted accelerator, an accelerator containing a deactivated metal chloride, and other impurities such as copper impurities, and the impurities other than the unreacted accelerator may be removed by washing the solid by-product through the alcohol supply unit.

The recovery tank may further include a dechlorinating agent supply unit. The activity of the accelerator may be improved by supplying the dechlorinating agent to the washed accelerator through the dechlorinating agent supply unit.

The recovery tank may further include a classifier. As the classifier is further included in a recovery zone, the accelerator may be classified by particle size. For example, particles having a size of 1 mm or more and particles having a size of less than 1 mm may be classified through a sieve device. In particular, since the char and the dechlorinating agent are aggregated in the accelerator, the accelerator may be recovered with a high yield by selectively recovering large particles through classification by particle size. Fine particulate carbides may cause problems such as clogging of the reactor and a reduction in process efficiency, and therefore it may be preferable to selectively recover only large particles excluding the fine particulate carbides. The recovered accelerator may be resupplied to the reactor through the recirculation line.

The removed impurities and the fine particulate carbides may be used as a fuel source for a batch reactor, which may contribute to fuel savings.

As for the contents not further described in the device for refining waste plastic pyrolysis oil, the description of the method for refining waste plastic pyrolysis oil described above may be used as reference.

Hereinafter, preferred Examples and Comparative Examples of the embodiments of the present disclosure will be described. However, each of the following Examples is merely a preferred example of the present disclosure, and the embodiments of the present disclosure are not limited to the following Examples.

### Example 1

Domestic mixed plastics including 3 wt % or more of PVC together with PE and PP were extruded at 250° C. to prepare 400 g of domestic waste plastic pellets. A content of chlorine in the domestic waste plastic pellets was 4,000 ppm. The inside of a batch reactor was purged with nitrogen gas to create a non-oxidizing atmosphere.

400 g of the domestic waste plastic pellets and 100 g of char were put into the batch reactor, and then pyrolysis was performed at 400° C. for 250 minutes while continuously supplying fuel. The produced pyrolysis product was transferred to a classification tank, pyrolysis gas was recovered from a second outlet located at the top of the classification tank, the recovered pyrolysis gas was collected in a condenser, waste plastic pyrolysis oil was finally recovered in a storage tank, and then a solid by-product was recovered to a recovery tank from a second outlet located at the bottom of the reactor.

Char produced in the following process was used as the char. The waste plastic was uniformly cut into a size of 150 to 200 mesh, and the cut waste plastic was put into a U-shaped reactor. Next, pyrolysis was performed by continuously flowing nitrogen at a flow rate of 50 ml/min at 600° C. for 2 hours using a proportional-integral-derivative (PID) controller. As a result, 100 g of char produced as a solid by-product was recovered and used.

### Example 2

Waste plastic pyrolysis oil was recovered by performing a reaction under the same conditions as those of Example 1, except that 110 g of aggregates in which the char and calcium oxide were aggregated were added instead of using the char alone. For the preparation of the aggregate, 100 g of the char and 10 g of the calcium oxide were used.

### Example 3

Waste plastic pyrolysis oil was recovered by performing a reaction under the same conditions as those of Example 1, except that a solid by-product included in the pyrolysis product of Example 2 was recovered instead of the char, and the recovered solid by-product was reused. Specifically, the solid by-product was recovered from the second outlet located at the bottom of the reactor to the recovery tank in Example 2, and then the recovered solid by-product was reused as the char of Example 1.

### Example 4

In Example 3, impurities included in the solid by-product were removed by supplying ethanol at a flow rate of 50 ml/min for 30 minutes through an ethanol supply unit of the recovery tank. Thereafter, only aggregates having a size of 1 mm or more were recovered through a sieve device, 10 g of calcium oxide was additionally supplied to the recovered aggregates to allow them to be aggregated and to improve the activity, and then the aggregates were reused as the char of Example 1.

### Comparative Example 1

Waste plastic pyrolysis oil was recovered by performing a reaction under the same conditions as those of Example 1, except that the reaction was performed without adding char.

### Comparative Example 2

Waste plastic pyrolysis oil was recovered by performing a reaction under the same conditions as those of Example 1, except that the reaction was performed by adding only calcium oxide without adding char.

### Evaluation Examples

The content (ppm) of chlorine in the recovered waste plastic pyrolysis oil was measured through ICP and XRF analysis.

The amount of fuel consumed during the pyrolysis process was measured.

TABLE 1

| | Example | Example | Example | Example | Comparative | Comparative |
|---|---|---|---|---|---|---|
| | 1 | 2 | 3 | 4 | Example 1 | Example 2 |
| Waste plastics (g) | 400 | 400 | 400 | 400 | 400 | 400 |
| Char (g) | 100 | 100 | 100 | 100 | — | — |
| Dechlorinating | — | 10 | 10 | 10 | — | 10 |
| agent (g) | | | | | | |
| Temperature | 400 | 350 | 400 | 400 | 400 | 400 |
| (° C.) | | | | | | |
| Chlorine in | 270 | 160 | 290 | 150 | 970 | 390 |
| pyrolysis oil (ppm) | | | | | | |
| Fuel | 50 | 51 | 49 | 47 | 60 | 62 |
| consumption (g) | | | | | | |

As in Example 1, in the case where the pyrolysis process was performed in the presence of char, it could be confirmed that the content of chlorine in the pyrolysis oil was 270 ppm, which was significantly reduced compared to the content of chlorine in the waste plastic raw material (content of chlorine of 4,000 ppm). In Example 2, it could be confirmed that as the aggregates in which char and calcium oxide were aggregated were used, the content of chlorine in the pyrolysis oil was 160 ppm, which was further reduced.

In addition, as in Example 3, in the case where the solid by-product included in the pyrolysis product of Example 2 was recovered and the recovered solid by-product was reused as the char, it could be confirmed that the content of chlorine in the pyrolysis oil was 290 ppm, which was significantly reduced compared to the content of chlorine in the waste plastic raw material. In particular, as in Example 4, in the case where the recovered solid by-product was washed with ethanol, calcium oxide was additionally added to improve the activity, and then it was reused as the char, it could be confirmed that the content of chlorine in the pyrolysis oil was 150 ppm, which was most reduced compared to the content of chlorine in the waste plastic raw material.

On the other hand, as in Comparative Example 1, in the case where the pyrolysis process was performed without adding char, it could be confirmed that the content of chlorine in the pyrolysis oil was 970 ppm, which showed that the chlorine was present in an excessive amount. As in Comparative Example 2, even in the case where only oxide calcium was added without char, it could be confirmed that the content of chlorine in the pyrolysis oil was 370 ppm, which showed that the chlorine was present in a significant amount.

In addition, in the cases of Examples 1 to 4, about 51 g or less of the fuel was consumed in the pyrolysis process. On the other hand, in the cases of Comparative Examples 1 and 2, it could be confirmed that about 60 g of the fuel was consumed, which showed that the char was effective in saving the fuel consumption through the acting of the char as a heat carrier.

Although embodiments of the present disclosure have been described, the present disclosure is not limited to the embodiments, but may be implemented in various different forms. It will be apparent to those skilled in the art to which the present disclosure pertains that the embodiments may be implemented in other specific forms without departing from the spirit of essential feature of the present disclosure. Therefore, it is to be understood that the embodiments described hereinabove are illustrative rather than restrictive in all aspects. Furthermore, the embodiments may be combined to form additional embodiments.

1. A method for producing waste plastic pyrolysis oil with reduced chlorine, the method comprising:
a first operation of charging a waste plastic raw material and an accelerator containing char into a reactor;
a second operation of pyrolyzing the waste plastic raw material in the reactor and recovering pyrolysis oil; and
a third operation of recovering the accelerator from the reactor.

2. The method of claim 1, wherein the accelerator in the first operation is charged into the reactor in an amount of 5 to 30 parts by weight with respect to 100 parts by weight of the waste plastic raw material.

3. The method of claim 1, wherein the accelerator further contains one or more dechlorinating agents selected from the group consisting of a metal oxide, a metal hydroxide, and a metal carbonate.

4. The method of claim 3, wherein the dechlorinating agent is a metal oxide.

5. The method of claim 3, wherein the accelerator is an aggregate in which a plurality of first particles containing char are bound and aggregated by the dechlorinating agent.

6. The method of claim 5, wherein the dechlorinating agent is an adhesive powder further containing moisture, and binds the plurality of first particles.

7. The method of claim 3, wherein the char is contained in the accelerator at a weight greater than that of the dechlorinating agent.

8. The method of claim 3, further comprising a fourth operation of resupplying the accelerator recovered in the third operation to the first operation.

9. The method of claim 8, wherein the fourth operation includes:
an operation of washing the accelerator recovered in the third operation with an alcohol;
an operation of replenishing the accelerator washed with the alcohol and the dechlorinating agent to prepare an accelerator; and
an operation of resupplying the prepared accelerator to the first operation.

10. The method of claim 1, wherein the second operation is performed at a temperature of 300 to 600° C.

11. The method of claim 1, wherein the second operation is performed in a non-oxidizing atmosphere.

12. The method of claim 9, further comprising, before the operation of resupplying the prepared accelerator to the first operation, an operation of additionally heating the prepared accelerator at 500 to 1,000° C. to improve activity of the accelerator.

13. A device for producing waste plastic pyrolysis oil with reduced chlorine, the device comprising:
a reactor into which a waste plastic raw material and an accelerator containing char are charged and in which a pyrolysis process is performed; and
a storage tank in which pyrolysis oil is recovered from the reactor.

14. The device of claim 13, further comprising:
a recovery tank that recovers the accelerator from the reactor; and
a recirculation line that resupplies the accelerator from the recovery tank to the reactor.
